(19) United States
(12) Patent Application Publication
(10) Pub. No.: US 2019/0092551 A1
(43) Pub. Date: Mar. 28, 2019

(54) A METHOD OF MAKING, COOKING AND PRESENTING A FOOD PRODUCT, AND PACKAGING FOR USE IN THIS METHOD

(71) Applicant: Lidl Stiftung & Co. KG, Neckarsulm (DE)

(72) Inventors: Stefan Schwarz, Neckarsulm (DE); Slawomir Wewiora, Praha (CZ)

(21) Appl. No.: 16/073,102

(22) PCT Filed: Jan. 26, 2017
(86) PCT No.: PCT/EP2017/051622

§ 371 Date: Nov. 26, 2018

(30) Foreign Application Priority Data
Jan. 27, 2016 (DE) 10 2016 101 467.2
Oct. 28, 2016 (DE) 10 2016 120 615.6

(51) Int. Cl. B65D 81/34; A23L 5/10; B65D 75/02

(52) U.S. Cl. CPC B65D 81/343; A23V 2002/00; B65D 75/02; A23L 5/15

(57) ABSTRACT

A method for cooking and presenting a food product is described. A ready to eat warm food product is provided in an attractive configuration while keeping handling simple. A method comprises the steps:
providing the food product in a frozen form in a packaging;
cooking the food product in an oven wherein the food product is arranged in the packaging during the cooking;
presenting the cooked food product in a provided heating arrangement to a customer wherein the food product is arranged in the packaging during the presenting, and the packaging including the cooked food product is retrievable by the customer from the heating arrangement, the method comprising the preceding steps:
producing the food product,
arranging the food product in at least one packaging,
freezing the food product in the packaging.

### I. FIELD OF THE INVENTION

The instant invention relates to a method for producing, cooking and presenting a food product and slip tray for the method. The method can be performed at least as soon as the food product is provided in frozen form, for example, in a grocery store. The store can be in particular a chain grocery store. The method can also be performed in gas stations, schools and universities in order to feed students and teachers, in businesses of all kinds to feed employees, and in food stands or similar facilities.

### II. BACKGROUND OF THE INVENTION

It is well known to heat instant meals, for example, in a dish made from aluminum, in a microwave oven. Instant meals that are packaged in a respective dish are available in food retail. A customer purchases the cold instant meal in the store and typically heats it at home. This method has significantly sped up home food preparation, but it is not preferred by consumers which do not wish to maintain an infrastructure to prepare food in their home.

### III. BRIEF SUMMARY OF THE INVENTION

### a) Technical Object

Thus it is an object of the instant invention to provide a method for producing, cooking and presenting a food product by which a ready-to-eat hot food product can be provided in an attractive configuration and which can be handled in a very simple manner. Another object of the invention is to provide a packaging for the method.

### b) Solution

According to the invention, a method for producing, cooking and presenting a food product is proposed. The method comprising the steps:
Providing the frozen food product in a packaging, in particular at a location where the food product is subsequently presented,
cooking the food product in a provided oven, in particular at the location where the food product is subsequently presented, wherein the food product is in the packaging during the cooking process, and
presenting the cooked food product in a provided heating arrangement, in particular a heating shelf for a customer wherein the food product is in the packaging during the presenting and the packaging including the cooked food product is retrievable from the heating arrangement by the customer through self-service.

The subsequent method steps can be performed before performing the method steps recited supra:
producing the food product (7),
arranging the food product (7) in at least one packaging,
deep freezing the food product (7) that is arranged in the packaging down to at least −18 degrees C., better −25 degrees C., better −30 degrees C.

The method can be performed at least starting with providing the frozen food product, for example, in a grocery store or a chain grocery store. In this case, at least the oven, advantageously a heat-radiation oven, in particular a forced-air oven, and the heating arrangement are provided in the store. It is also conceivable that freezers for intermediary storage of the frozen food products that are contained in the packaging are provided in the store.

The inventors have found that the method can be performed in a particularly simple and effective manner when the food product is continuously arranged in its packaging at least over an entire time period from being provided in the frozen form, in particular from its production, up to the point in time when the customer retrieves a cooked food product from the heating arrangement. This means that the food product is in the packaging in frozen condition, remains in the packaging during cooking in the oven and eventually stays in the packaging during the phase of presenting it to the customer in the heating arrangement wherein the food product was previously frozen and cooked in the packaging. The packaging is thus advantageously configured so that the food product is at least partially visible to a customer that looks at the packaging.

When the packaging is a form stable packaging, like a dish or a basket-shaped carry container, the food product is inserted into this form stable packaging. However, when the packaging is a non-form stable packaging like, e.g., a wrapping paper or a wrapping foil, the food product is enveloped therewith in particular tightly enveloped, in particular wrapped, and can be additionally introduced in particular inserted in this condition together with the non-form stable packaging into a form stable packaging.

The packaging that is used for the method according to the invention is configured so that it tolerates typical freezing temperatures of at least −18 degrees C., in particular −20 degrees C., in particular −30 degrees C. The packaging shall tolerate high temperatures of at least 140 degrees C., better at least 180 degrees C., better at least 220 degrees C., occurring during cooking and shall be advantageously nonflammable up to this temperature.

Additionally the packaging can be configured in an aesthetically appealing configuration so that it can represent an additional purchasing stimulus or consumption stimulus for the client.

It is particularly advantageous for the employees of an operator of the method according to the invention that they do not have to directly contact the cooked and heated food products by hand during transportation from the oven into the heating arrangement. The packaging that is used during the method according to the invention can be configured so that it is either heated very little, and/or includes a carrying handle. Burns through direct contact with the hot food products can thus be avoided.

The packaging of the food product is performed according to the invention during or before the freezing process, the cooking process and the presenting process, during which the food product is kept warm.

Employees of the operators of the method, therefore, do not have to handle packaging that is spatially removed from the food product at any point in time. The entire logistics can be omitted which would be required for packaging that needs to be handled separately wherein the food product would be inserted into the packaging after cooking. Thus the process of cooking and presenting the cooked food product is significantly facilitated for the employee. Additionally, logistics for separate packaging that would be required for each location where the method according to the invention is performed are redundant. According to the invention, an aesthetically appealing presentation of the food products for the customers is consequently reached with significantly reduced handling and logistics complexity.

It is another advantageous of the method according to the invention that environmental resources are being used sparing. Intermediary packaging like baking paper or similar is not required anymore. Furthermore, high hygiene requirements can be complied with since it is not necessary in any method step to remove the food product from the packaging and to touch it by hand in any way.

Food products according to the instant invention can be, for example, instant meals of all types, meat products, in particular chicken pieces, baked goods, bread or other bread products, sandwiches or buns, burgers, wraps, pastry like apple pie, curry sausages, meatloaf, potato products like, e.g., potato puffs or similar.

Before freezing of the food products the food products can be precooked, in particular pre-roasted, pre-sautéed, pre-fried or pre-baked. Arranging the food product in the packaging can be optionally performed before or after the precooking or prebaking, in any case, before freezing the precooked or prebaked cooked food product.

Accordingly the cooking of the food products can also only be a finish cooking of precooked or prebaked food products. For food products which were already completely cooked before freezing cooking according to the invention only means a heating in the provided oven.

From the heating arrangement that is advantageously configured as a heating shelf, in which the packaged in particular hot food product is eventually presented the customer can retrieve a ready to eat hot food product by self-service.

It is particularly advantageous to provide a portable thermos container in the heating arrangement for thermal insulation of the cooked food product. The customer can then place the packaging including the cooked food product arranged therein into the thermos container and transport it. This way it is possible to keep the food product warm until it is actually consumed. The actual consumption, however, can be performed directly on side, so that the thermos container becomes redundant. The same applies for the case where the customer retrieves the food product from the heating arrangement for to-go consumption.

The packaging can include a form stable packaging, in particular a dish and a slip tray that is advantageously made from cardboard in which the dish with the food product is insertable. The material of the dish and the material of the slip tray are configured sufficiently cold and heat resistant for purposes of the instant invention. When the slip tray is made from cardboard it is typically made from a corrugated cardboard material. The cardboard material of the slip tray can be made sufficiently heat resistant, for example, by a coating with a foil, in particular a PET foil.

Advantageously one or plural pass-through openings are provided in the surface of the slip tray which forms the topside of the packaging. The pass-through openings support air circulation between the interior of the packaging and the ambient so that no condensation water is formed in the packaging which could dilute the food product. This helps to prevent detrimental impacts upon taste and freshness of the food product. Furthermore, radiation heat that impacts the packaging from above can impact the food product to be cooked directly.

It is advantageous when the sum of the surfaces of all provided pass-through openings forms a perforated surface which represents at least 15%, advantageously at least 25%, of the surface of the slip tray that forms the topside of the packaging, wherein the perforated surface is included in the surface that forms on the topside of the packaging.

Independently from the actual type of the food product the packaging can also be advantageously configured as a basket-shaped carry container with a carry handle. The carry container is advantageously made from cardboard or corrugated material and can be carried like a basket with the food product included therein.

The instant invention furthermore proposes a slip tray for a dish to receive a food product wherein the dish is insertable into the slip tray or pullable from the slip tray. According to the invention, the slip tray includes a closing wall at a topside for closing the dish, wherein the closing wall is provided with one or plural pass-through openings.

Advantageously the sum of the surfaces of all provided pass through openings yields a perforated surface which amounts to at least 15%, advantageously at least 25%, of the surface of the entire closing wall including the perforated surface.

The slip tray is provided with at least one side opening for inserting the tray or pulling the tray out. In a portion that is adjacent to the side opening the closing wall of the slip tray includes a recess which leaves an engagement opening open for engaging the dish wish at least one finger or a tip of a finger in a condition of the dish where the dish is completed inserted into the slip tray. Thus the dish can be gripped in a simple manner at its exposed side wall and pulled out from the slip tray.

It is advantageous that the engagement opening has a first extension in the insertion direction for inserting the dish into the slip tray wherein the extension is smaller than 15%, advantageously smaller than 10%, of the dimension of the tray in the insertion direction.

The slip tray is advantageously made from a heat and freezing resistant cardboard which can be coated with a foil.

On the one hand side the packaging can be, e.g., a non-form stable packaging, in particular an enveloping material, in particular an enveloping paper or an enveloping foil.

A non-form stable packaging means that the packaging does not essentially maintain its initial shape, merely due to its own weight in any holding position when holding the packaging only at a small surface of the packaging. The non-form stable packaging is in part a very thin plate-shaped packaging which does not maintain its flat starting condition transversal to its main plane when supported only at an edge of the plate and arranged approximately horizontally but which bends already solely under its proper weight. This applies, e.g., for typical wrapping papers or wrapping foils that are used to wrap food products, e.g., bread or meat products.

A wrapping material of this type can advantageously be greaseproof and can be coated for this purpose, in particular with wax or polyethylene, so that grease running out of the food product cannot penetrate to the outside.

Additionally a wrapping material of this type, in particular a wrapping paper or a wrapping foil, shall advantageously have additional properties that are advantageous for the intended purpose, namely that individually or in combination:

the wrapping material, in particular the wrapping paper, is grease-tight or coated with a grease-tight material, in particular, wax or polyethylene, which has a grease tigtheness according to DIN 3116 stage III.

the wrapping material (11) is temperature resistant, in particular non-flammable, up to at least 140 degrees C., in particular up to at least 180 degrees C., in particular up to at least 220 degrees C.

the wrapping material (11) in the recited minimum temperature resistance portion, has a fracture resistance according to ISO 1924 of at least 3.0 kN/m, better at least 3.5 kN/m, better at least 3.7 kN/m in the longitudinal direction, and in the transversal direction of at least 1.2 kN/m, better at least 1.5 kN/m, better at least 1.7 kN/m.

the wrapping material (11) has a burst resistance according to Mullen, in particular according to DIN 2758, of at least 110 kPa, better at least 130 kPa, in particular in the recited minimum temperature resistance range, however at in particular 20 degrees C.

### c) EMBODIMENTS

Subsequently two embodiments of the instant invention are described in an exemplary manner, with reference to drawing figures:

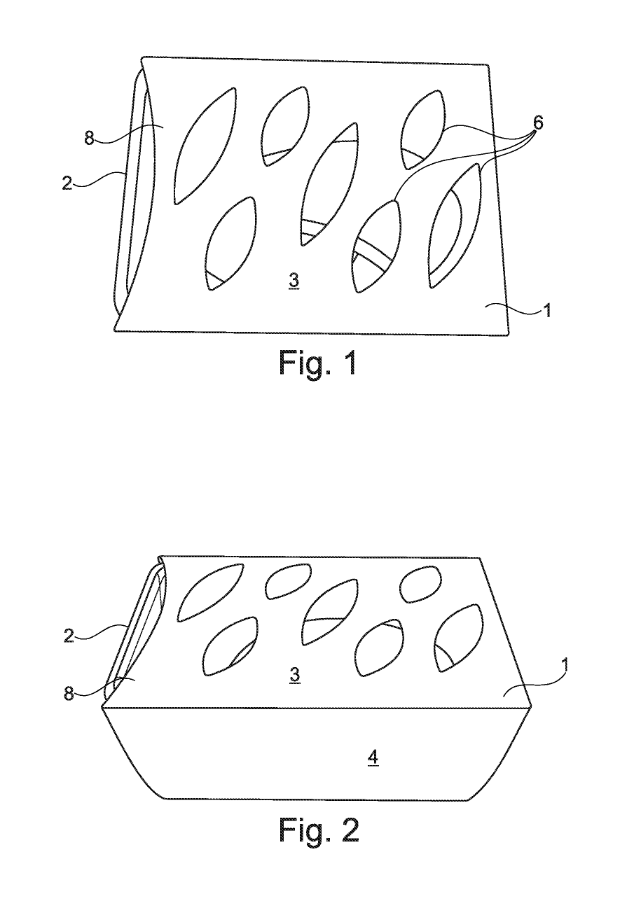

FIG. 1 Illustrates a top view of a first embodiment of a packaging comprising a dish and a cardboard slip tray;

FIG. 2 Illustrates a perspective view of the packaging illustrated in FIG. 1;

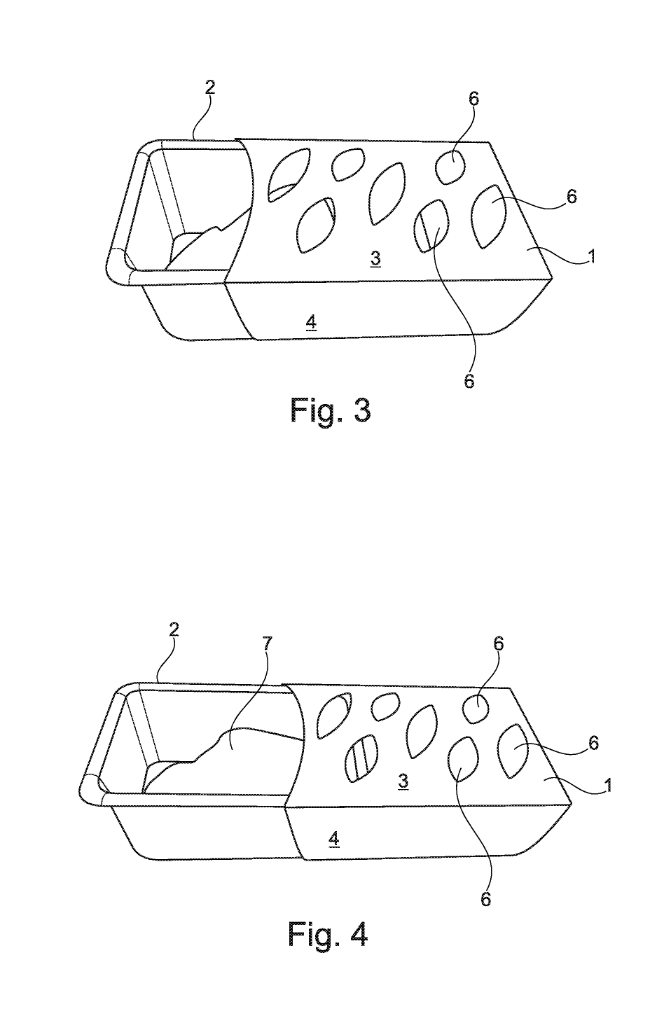

FIG. 3 Illustrates a perspective view of the packaging illustrated in FIG. 2 with a slightly pulled out dish;

FIG. 4 Illustrates a perspective view of the packaging illustrated in FIG. 2 with a dish that is pulled out even further;

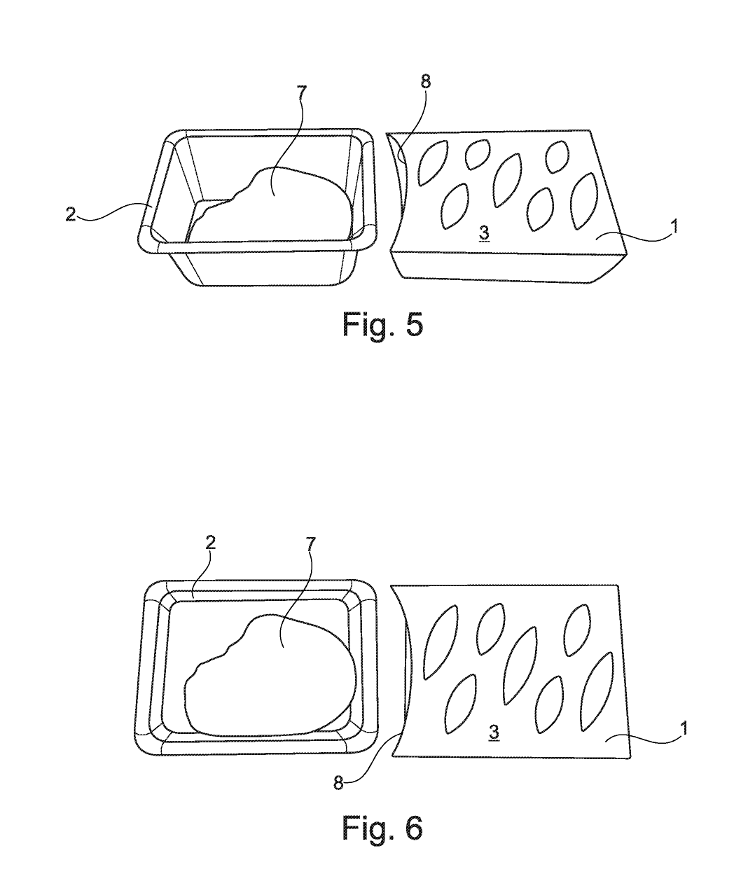

FIG. 5 Illustrates a perspective view of the packaging illustrated in FIG. 2 wherein the dish is completed pulled out of the cardboard slip tray;

FIG. 6 Illustrates a top view of the packaging illustrated in FIG. 5;

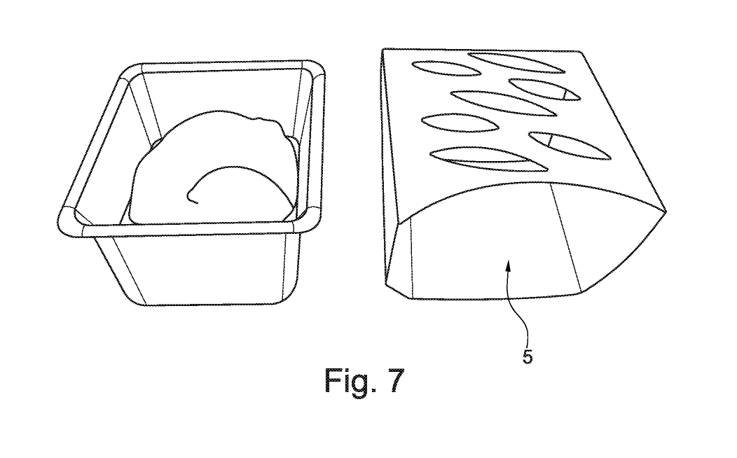

FIG. 7 Illustrates a perspective view of the packaging illustrated in the preceding figures, wherein the dish is completely pulled out of the cardboard slip tray and the viewing direction extends essentially in the direction in which the tray is slid into the cardboard slip tray;

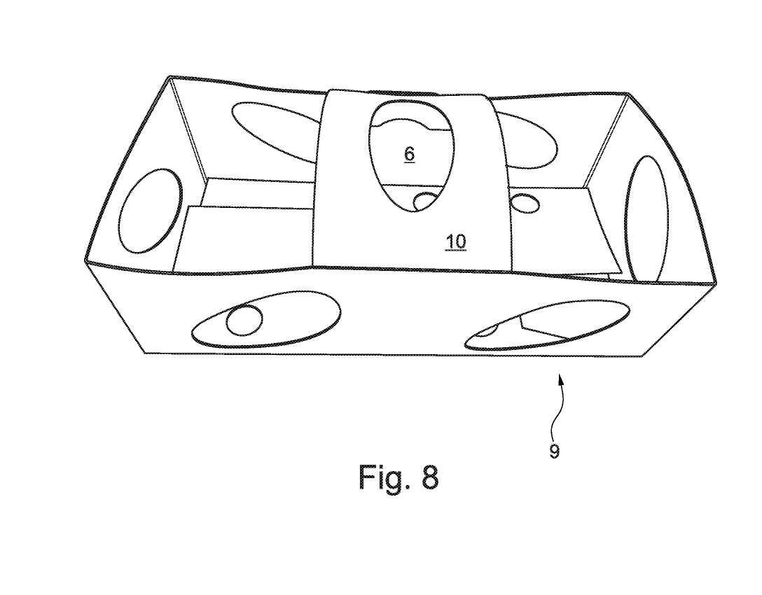

FIG. 8 Illustrates a perspective side view of a second embodiment of a packaging;

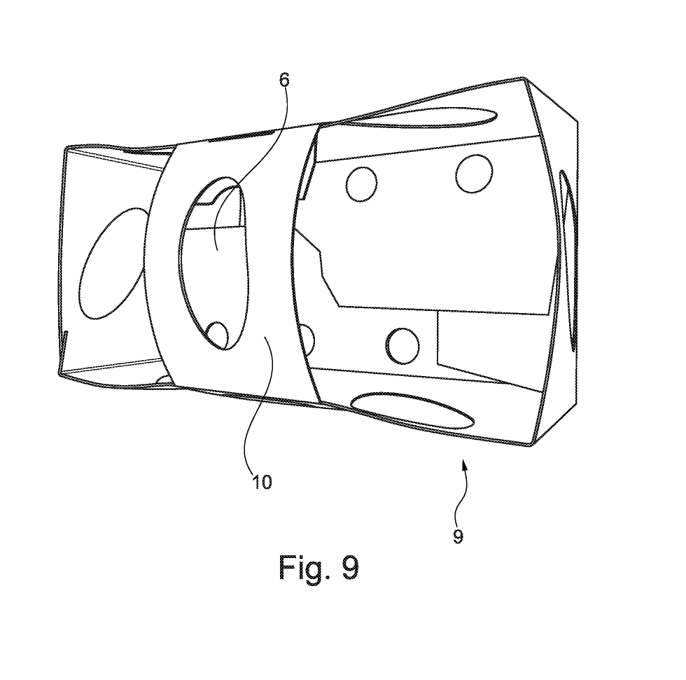

FIG. 9 Illustrates a perspective view from a right side of the packaging illustrated in FIG. 8.

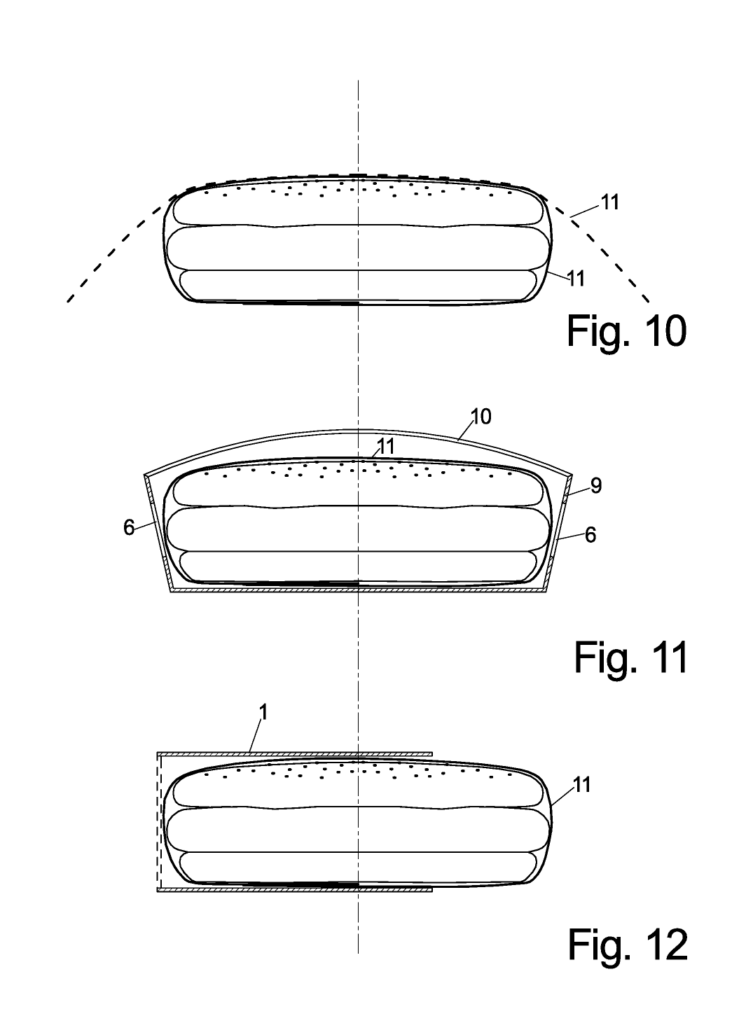

FIG. 10 Illustrates a burger wrapped in the wrapping material in a sectional view.

FIG. 11 Illustrates the wrapped burger according to FIG. 10 inserted into a carry container

FIG. 12 Illustrates a wrapped burger according to FIG. 10 inserted into a slip tray

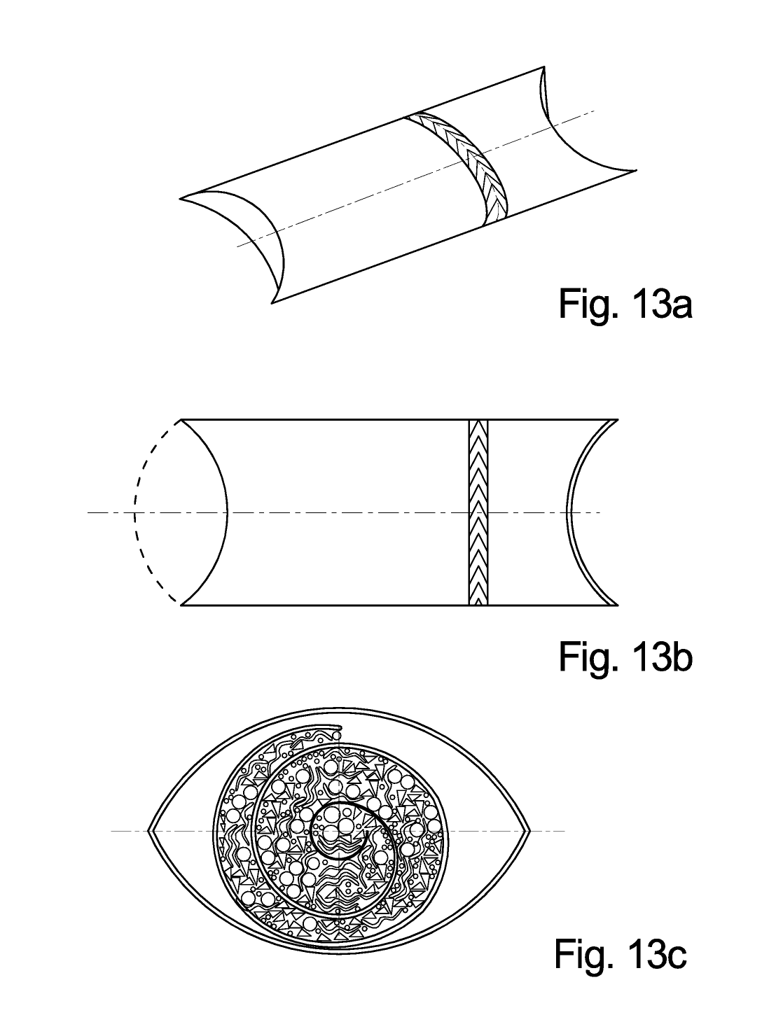

FIGS. 13a-c illustrate views of an additional embodiment of a form stable packaging configured as a closable paper sleeve.

FIGS. 1 and 2 illustrate a first embodiment of a packaging which is usable for the method according to the invention. The packaging includes a black dish 2 and a cardboard slip tray 1. The cardboard slip tray 1 includes a total of five walls, wherein the drawing figures only show the closing wall 3 and a side wall 4. The face of the slip tray 1 that is on the left in the drawing figures is completely open as evident from FIG. 7 which shows the face opening 5 of the cardboard slip tray 1. Alternatively it is conceivable to configure the cardboard slip tray 1 open not at short face but at the long lateral side in order to insert the dish 2. This case the face opening 5 is closed and the face wall 4 is not provided.

As evident in FIGS. 1 through 7 the closing wall 3 of the slip tray 1 includes seven pass-through openings 6 in the illustrated embodiment which facilitate a circulation of air from the ambient into an interior of the packaging or of the dish 2. A formation of condensation water at the inner walls of the dish 2 and at the inside of the closing wall 3 is thus advantageously avoided. Furthermore, radiation heat can propagate better through the pass-through walls 6 into the interior of the packaging and thus to the food product 7 to be cooked. In the illustrated embodiment the food product 7 is a half chicken.

It is evident from FIGS. 1 through 6 that the closing wall 3 includes an arcuate recess at its left edge in the illustrated embodiment. As evident from FIGS. 1 and 2 the recess 8 is sized so that the left side wall of the dish 2 is exposed when the dish 2 is completely inserted into the cardboard slip tray 1 and additionally an inside of the left side wall of the dish 2 is visible in FIGS. 1 through 6 though the recess 8. Between the arcuate border of the recess 8 and the inside of the left sidewall of the dish 2 this creates a narrow elongated reach in opening through which the left side wall of the dish 2 can be gripped with a finger and the dish 2 can then be pulled out of the cardboard slip tray 1 to the left.

FIGS. 3 through 7 illustrate various conditions of the packaging in which the dish 2 is pulled more or less or the cardboard slip tray 1. In FIGS. 5, 6 and 7, the dish 2 with the food product 7 arranged therein is pulled out of the cardboard slip tray 1 in its entirety.

The pass-through openings 6 can have any geometry. Differently from the illustrated embodiment with eye slit shaped pass-through openings 6 also circular geometries are conceivable. A total of a surface area of all seven pass-through openings 6 is greater than 20% of an entire surface of the closing wall 3. In this context the entire surface of the closing wall 3 is formed by the portion of the closing wall 3 that is not penetrated by the pass-through openings 6 but also the surface of the pass-through openings 6 itself. The recess 8 at the left side of the closing wall 3 which releases an inlet opening into the interior of the dish 2 is neither part of the entire surface of the cardboard slip tray 1 nor of the sum of the surfaces of the pass-through openings 6.

FIGS. 8 and 9 illustrate a second embodiment of a packaging that is usable for the method according to the invention and configured as a basket-shaped cardboard carrying container 9. The carrying container is used in the illustrated embodiment to package sandwiches; a carry handle 10 facilitates transporting the cooked hot sandwich without having to touch the sandwich directly. It is evident that the cardboard carry container 9 includes access openings on both sides of the carry handle 10 and several oval viewing openings. A pass-through opening 6 is provided in the carry handle 10 wherein the pass-through opening 6 improves air circulation like the pass-through openings 6 in the first embodiment according to FIGS. 1 through 7 and renders the interior of the basket-shaped cardboard carry container 9 accessible for radiation heat more easily.

The packaging illustrated in FIGS. 1 through 7 or 8 and 9 receive the frozen chicken or the frozen sandwich. Advantageously the chicken or the sandwich is already in the respective packaging during the freezing. In this frozen condition the chicken or the sandwich are delivered to the stores of the grocery chain. There they can be stored in an intermediary manner in freezers. When they are to be cooked or the cooking finished, they are placed into the dish 2 and into the cardboard slip tray 1 or into the cardboard carry container 9 into an oven where the cooking is performed. After finishing the cooking process the cooked chicken or the cooked sandwich is placed into a heating shelf where they are kept warm.

The heating shelf is for the customers to serve themselves. Using suitable doors or other opening mechanisms the customer can access an interior of the heating shelf as required and can retrieve the cardboard slip tray 1 with the dish 2 and the chicken arranged therein, or the basket shaped cardboard carry container 9 with the sandwich arranged therein. From the point in time of deep freezing until at least to the point of retrieval from the heating shelf by the customer the cardboard slip tray 1 with the dish 2 and the chicken arranged therein or the basket shaped cardboard carry container 9 with the sandwich arranged therein always forms a unit that can be handled in a practical manner. Neither store employees nor customers have to take care at any point in time that the chicken with the dish 2 moves into the cardboard slip tray 1 or the sandwich moves into the cardboard carry container 9.

FIGS. 13 a through c illustrate an additional form stable packaging configured as a cardboard sleeve 12, into which a food product can be inserted, and which then can be closed on both sides.

For this purpose the tube-shaped carboard shaped sleeve 12 advantageously has a lenticular cross-section and can be closed at the face end by folding a flap 14 over, wherein the flap is a component of the wall of the tubular center element of the cardboard sleeve 12 into a closing position that is arranged transversal to an extension direction 12′ of the tubular center piece which then closes the lenticular cross section.

Each of the two face ends advantageously includes respectively at least one or also two opposite fold flaps 14 which advantageously have a recess 15 at their free end edge for engaging with a finger in order to be able to open the fold flap 14 again.

Typically the closed cardboard sleeve 12, which is then advantageously filled with a food product like, e.g., a fold-over pie, is opened wherein the user grips an outer strip 13 that extends about entire circumference in the center portion of the cardboard sleeve at a grippable end and the ripped open strip is completely separated from the cardboard sleeve which cuts the cardboard sleeve into two components.

The one, typically longer portion, is then used for supporting the food product wherein the food product protrudes at a face, thus at an end where the tear off strip 13 was previously arranged.

The food product can be inserted directly into the cardboard sleeve 12 or together with a non-form stable wrapping material like a wrapping paper that envelopes the food product.

FIG. 10 illustrates a sectional view of a burger, which is enveloped by a non-form stable wrapping material, in particular a wrapping paper.

Thus, a dashed line illustrates an approximately flat condition of the wrapping material 11, and the original condition as placed on the burger wherein edges that laterally protrude beyond the burger only hang down slightly, wherein the laterally protruding edge portions of the wrapping material 11 are bent down manually from the starting condition and are run below the base of the burger and overlap at this location. Due to the overhang that is provided on all sides, the burger is then enveloped by the wrapping material 11 entirely. Through the proper weight of the burger on the overlapping portion of the wrapping material this packaging that is not form-stable by itself is closed, in particular also in a frozen condition.

In spite of that a burger that is enveloped according to FIG. 10 can be additionally inserted into a carry container 9 that is substantially open on a top side, dish shaped or basket shaped and for example only includes a carry handle 10 that reaches transversally over the upper opening wherein the carry container advantageously has pass through openings 6 in its side walls wherein hot ambient air can reach the burger through the pass through openings during cooking in order to heat the burger.

Thus the customer only has to grip the carry container, in particular only its handle 10, which has less heat capacity and thus feels less hot than the very thin wrapping material that contacts the burger and which has a temperature that is approximately identical to a temperature of the burger,

For the same reason the burger enveloped according to FIG. 10 can also be inserted into a slip tray 1 which advantageously tightly envelopes the burger on a top side and on a bottom side which keeps the overlap of the wrapping material 11 under the burger in position.

The slip tray 1 can be a sleeve that is open on both sides or it can be closed at one face so that it forms a pocket that is open on one side.

The form stable carry container 9 can be made from a cardboard material like the form stable slip tray 1,

### REFERENCE NUMERALS AND DESIGNATIONS

1 Cardboard slip tray

2 Dish

3 Closing wall

4 Side wall

5 Side openings

6 Pass through opening

7 Food product

8 Cut out

9 Cardboard carry container

10 Carry handle

11 Wrapping material, wrapping paper, wrapping foil

12 Cardboard sleeve

13 Tear-off strip

14 Folding flap

1. A method for cooking and presenting a food product, the method comprising the steps:
providing the food product (7) in a frozen form in a packaging (1, 2; 9);
cooking the food product (7) in an oven wherein the food product (7) is arranged in the packaging (1, 2; 9) during the cooking;
presenting the cooked food product (7) in a provided heating arrangement to a customer wherein the food product (7) is arranged in the packaging (1, 2; 9) during the presenting, and the packaging (1, 2; 9) including the cooked food product (7) is retrievable by the customer from the heating arrangement, the method comprising the preceding steps:
producing the food product (7),
arranging the food product (7) in at least one packaging,
freezing the food product (7) in the packaging.

2. The method according to claim 1, characterized in that,
the packaging includes a form stable carry container.

3. The method according to claim 1 or 2 characterized in that,
a portable thermo container is provided in order to thermally insulate the cooked food product (7) wherein the packaging (1, 2; 9) including the cooked food product (7) is transportable in the portable thereto container after retrieval from the heating arrangement.

4. The method according to claim 1, 2 or 3, characterized in that,
the packaging is formed by an in particular form stable dish (2) in which the food product (7) is arranged and a form stable slip tray (1) in to which the dish (2) is insertable.

5. The method according to claim 4, characterized in that,
the slip tray (1) includes a closing wall (3) with one or plural pass-through openings (6) at a top side of the slip tray.

6. The method according to claim 5, characterized in that,
all pass-through openings (6) combined form a pass-through surface which includes at least 15% of a surface of the entire closing wall (3) including the pass-through surface.

7. The method according to claim 1, 2 or 3, characterized in that,
the packaging is formed by a basket-shaped carry container (9) with a carry handle (10).

8. The method according to claim 1, characterized in that
the packaging includes a plate-shaped wrapping material (11) which is not form stable transversal to its main plane, in particular a wrapping paper (11), and/or a wrapping foil (11) which is in particular closely wrapped or wound about the food product (7), so that it advantageously envelops the food product (7) completely.

9. The method according to claim 8, characterized in that
the food product (7) arranged in the wrapping material (11) is introduced into a form stable carry container, in particular into the slip tray (1), the dish (2) or the basked shaped carry container (9), in particular before deep freezing.

10. A packaging, comprising:
a slip tray (1) that is in particular form stable with a dish (2) for receiving a food product (7) wherein in the dish (2) that is in particular form stable is insertable into the slip tray (1), and/or
a plate shaped wrapping material (11) that is not form stable transversal to its main plane, in particular a wrapping paper (11), and/or a wrapping foil (11).

11. The packaging according to claim 10 characterized in that
the slip tray (1) includes a closing wall (3) with one or plural pass-through openings (6) at a top side of the slip tray.

12. The packaging according to claim 11, characterized in that,
all pass-through openings (6) in combination have a pass-through surface which amounts to at least 15% of the surface of the closing wall (3) including the pass-through surface itself.

13. The packaging according to claim 10, 11 or 12, characterized in that,
the slip tray (1) includes at least one side opening (5) for inserting the dish (2) wherein the closing wall (3) includes a cutout (8) in a portion adjacent to the side opening (5) wherein the cutout leaves a handling opening for gripping the dish (2) open in an inserted condition of the dish (2) so that the dish (2) can be pulled out of the slip tray (1).

14. The packaging according to claim 13, characterized in that,
the handling opening has an extension in an insertion direction for inserting the dish (2) into the slip tray (1) wherein the extension is less than 15% of the dimension of the slip tray (1) in the insertion direction.

15. The packaging according to one of the claims 10 through 13, characterized in that,
the slip tray (1) is made from cardboard.

16. The packaging according to claim 15, characterized in that,
the cardboard is provided with a heat resistant coating.

17. The packaging according to claim 16, characterized in that,
the coating is a foil.

18. The packaging according to claim 10, characterized in that
the wrapping material, in particular the wrapping paper is grease tight or coated with a grease tight material, in particular wax or polyethylene which has in particular a grease tightness according to DIN-3116 stage 3.

19. The packaging according to claim 10 or 18, characterized in that
the wrapping material (11) is temperature resistant, in particular non-flammable at least up to 140° C., in particular up to at least 180° C., in particular up to at least 220° C.

20. The packaging according to claim 19, characterized in that,
the wrapping material (11) has a tensile strength according to ISO 1924 of at least 3.0 kN/m, better at least 3.5 kN/m, better at least 3.7 kN/m in the longitudinal direction and in the transversal direction of at least 1.2 kN/m, better at least 1.5 kN/m, better at least 1.7 kN/m.

21. The packaging according to claim 19 or 20, characterized in that
the wrapping material (11) has a burst resistance according to Mullen, in particular according to DIN 2758 of at least 110 kPa, better at least 130 kPa, in particular in the recited minimum temperature resistance range, in particular however at 20° C.

22. The packaging according to claim 10 or one of the claims 18 -21, characterized in that
the wrapping material (11) has a specific weight of at the most 45 g/m², better at the most 40 g/m², better at the most 30 g/m², better at the most 25 g/m², in particular with a deviation from a nominal value of at the most +/− 3 g/m^{2.}

23. The packaging according to claim 10 or one of the claims 18-22, characterized in that
the wrapping material (11) has a thickness of 0.20 mm at the most, better 0.15 mm at the most, better 0.10 mm at the most.

24. The packaging according to claim 10 or one of the claims 18-23, characterized in that
the wrapping material (11) is made from plant fibers, in particular cellulose fibers, by at least 50% better by at least 60%, better by at least 70%, better by at least 80%.
